(19) United States
(12) Patent Application Publication
(10) Pub. No.: US 2017/0298238 A1
(43) Pub. Date: Oct. 19, 2017

(54) HARD COAT FILM AND OPTICAL FILM FOR DISPLAY DEVICE

(71) Applicant: NIPPON PAPER INDUSTRIES CO., LTD., Tokyo (JP)

(72) Inventors: Yasuomi UCHIDA, Higashimatsuyama-shi (JP); Takeo SUZUKI, Higashimatsuyama-shi (JP); Yusuke SUGIYAMA, Higashimatsuyama-shi (JP); Takayoshi NOMURA, Higashimatsuyama-shi (JP); Takeshi HOTTA, Higashimatsuyama-shi (JP)

(73) Assignee: NIPPON PAPER INDUSTRIES CO., LTD., Tokyo (JP)

(21) Appl. No.: 15/514,313

(22) PCT Filed: Sep. 27, 2015
(86) PCT No.: PCT/JP2015/077224

§ 371 Date: Mar. 24, 2017

(30) Foreign Application Priority Data
Sep. 27, 2014 (JP) 2014-197671
Sep. 27, 2014 (JP) 2014-197672

(51) Int. Cl. C09D 7/06; G02B 1/14; C09D 4/00; C09D 7/12

(52) U.S. Cl. CPC C09D 7/06; C09D 7/125; G02B 1/14; C09D 4/00

(57) ABSTRACT

The present invention provides a hard coat film that has an excellent adhesion to the substrate of the hard coat layer and excellent hardness, that has an excellent coating surface without optical unevenness, and that has a high adhesion to acrylic adhesives used to join the hard coat layer and a liquid crystal display member, etc., while having excellent peeling properties from natural rubber-based adhesives.

The present invention is a hard coat film comprising a film substrate, and a hard coat layer formed on the film substrate and containing one or more electron beam-curable resins and one or more leveling agents. The above one or more electron beam-curable resins include, for example, a polyfunctional (meth)acrylate resin having 3 or more (meth)acryloyl groups, and the above one or more leveling agents include polyester-modified polydimethylsiloxane.

### TECHNICAL FIELD

The present invention relates to a hard coat film comprising a film substrate and a hard coat layer formed on the film substrate. The present invention particularly relates to a hard coat film used on the surface of CRT displays and flat panel displays (liquid crystal display bodies, plasma displays, EL displays, touch panel displays, etc.). The present invention also relates to an optical film for display devices, the optical film using the hard coat film.

### BACKGROUND ART

For liquid crystal displays, CRT, plasma displays, outdoor display panels, electronic scoreboards, and like various display bodies or glass, hard coat films comprising a thermoplastic resin film as a substrate, and a hard coat layer formed on the substrate are used for the purpose of protecting their surface. Particularly for flat panels typified by liquid crystal displays, triacetyl cellulose films are used as substrates because of their high light transmittance, few drawbacks, low polarization properties, etc.

In a hard-coat treatment method, a curable resin, such as an electron beam-curable resin, is applied and cured on the surface of a thermoplastic resin film to thereby form a hard coat layer. Electron beam-curable resins are composed of a monomer, an oligomer, a photoinitiator, etc. Three-dimensional crosslinking occurs upon irradiation with electron beams, and hardness is developed.

Moreover, silicone-based, fluorine-based, or acrylic leveling agents are generally mixed in hard coat layers for the purpose of improving surface flatness and coating properties. Particularly for hard coat films used in liquid crystal displays, leveling agents are used to suppress optical unevenness (see PTL 1 and PTL 2 below).

Furthermore, when a hard coat film is used in a liquid crystal display, the liquid crystal display has a laminated structure using many optical films. Accordingly, some hard coat layers of hard coat films used in liquid crystal displays are used in a form in which the hard coat layers are firmly bonded to another optical film, a case, etc., through an adhesive, such as an acrylic adhesive. Further, other hard coat layers are used in a form in which a protective film is bonded to the hard coat surface through an adhesive with weak adhesion force (e.g., a natural rubber-based adhesive).

### CITATION LIST

### Patent Literature

### PTL 1: JP2005-288286A

### PTL 2: JP2013-071274A

### SUMMARY OF INVENTION

### Technical Problem

However, when silicone-based and fluorine-based leveling agents, both of which have high leveling adjustment action, are used, the silicone-based and fluorine-based leveling agents bleed on the surface of the hard coat layer, thereby causing problems that the surface polarity of the hard coat layer is lowered, and that the adhesion to acrylic adhesives is reduced. In contrast, when an acrylic leveling agent, which is less likely to cause a reduction in the polarity of the hard coat layer due to the addition thereof, and which has a high adhesion to acrylic adhesives, is used, there are problems that sufficient leveling adjustment action is not obtained, optical unevenness occurs, and the adhesion between the hard coat layer and the substrate is inferior.

Accordingly, an object of the present invention is to provide a hard coat film that has an excellent adhesion to the substrate of the hard coat layer and excellent hardness, that has an excellent coating surface without optical unevenness, and that has a high adhesion to acrylic adhesives used to join the hard coat layer and a liquid crystal display member, etc., while having excellent peeling properties from natural rubber-based adhesives. Another object of the present invention is to provide an optical film for display devices, the optical film using the hard coat film.

### Solution to Problem

In order to solve the above problems, the present invent ion provides inventions having the following structures.

### (First Invention)

A hard coat film comprising a film substrate, and a hard coat layer formed on the film substrate and containing one or more electron beam-curable resins and one or more leveling agents,

wherein the one or more leveling agents include polyester-modified polydimethylsiloxane.

### (Second Invention)

A hard coat film comprising a film substrate, and a hard coat layer formed on the film substrate and containing one or more electron beam-curable resins and one or more leveling agents,

wherein polyester-modified polydimethylsiloxane and a fluorine group-containing monomer or polymer are contained as the one or more leveling agents.

### (Third Invention)

The hard coat film according to the first or second invention, wherein the one or more electron beam-curable resins include a polyfunctional (meth)acrylate resin having 3 or more (meth)acryloyl groups.

### (Fourth Invention)

The hard coat film according to the first or third invention, wherein the amount of the polyester-modified polydimethylsiloxane ranges from 0.1 wt. % to 3.0 wt. % based on the amount of the one or more electron beam-curable resins in the hard coat layer.

### (Fifth Invention)

The hard coat film according to the second or third invention, wherein the total amount of the one or more leveling agents, including polyester-modified polydimethylsiloxane and a fluorine group-containing monomer or polymer, contained in the hard coat layer ranges from 0.1 wt. % to 3.0 wt. % based on the amount of the one or more electron beam-curable resins.

### (Sixth Invention)

The hard coat film according to the fifth invention, wherein the compounding ratio of polyester-modified polydimethylsiloxane and a fluorine group-containing monomer or polymer, which are the one or more leveling agents contained in the hard coat layer, is within the following range: polyester-modified polydimethylsiloxane:fluorine group-containing monomer or polymer=50 wt. % to 95 wt. %:50 wt. % to 5 wt. %.

### (Seventh Invention)

The hard coat film according to any one of the first to sixth inventions, wherein the hard coat layer has a film thickness ranging from 1 to 20 μm.

### (Eighth Invention)

The hard coat film according to any one of the first to seventh inventions, wherein a value defined by the formula: the film thickness (μm) of the hard coat layer×the total amount (wt. %) of the one or more leveling agents mixed, ranges from 0.1 to 60.0 (μm·wt. %).

### (Ninth Invention)

An optical film for a display device, the optical film using the hard coat film according to any one of the first to eighth inventions.

### Advantageous Effects of Invention

The present invention can provide a hard coat film that has an excellent adhesion to the substrate of the hard coat layer and excellent hardness, that has an excellent coating surface without optical unevenness, and that has a high adhesion to acrylic adhesives used to join the hard coat layer and a liquid crystal display member, etc., while having excellent peeling properties from natural rubber-based adhesives.

Furthermore, an optical film for display devices having excellent characteristics can be provided by using the hard coat film of the present invention.

### DESCRIPTION OF EMBODIMENTS

Embodiments of the present invention are described in detail below.

One embodiment of the hard coat film according to the present invention is characterized in that the hard coat film comprises a film substrate, and a hard coat layer formed on the film substrate and containing one or more electron beam-curable resins and one or more leveling agents, wherein the one or more leveling agents include polyester-modified polydimethylsiloxane, as stated in the first invention above.

Moreover, another embodiment of the hard coat film according to the present invention is characterized in that the hard coat film comprises a film substrate, and a hard coat layer formed on the film substrate and containing one or more electron beam-curable resins and one or more leveling agents, wherein polyester-modified polydimethylsiloxane and a fluorine group-containing monomer or polymer are contained as the one or more leveling agents, as stated in the second invention above.

Furthermore, in the first or second invention, the one or more electron beam-curable resins include a polyfunctional (meth)acrylate resin having 3 or more (meth)acryloyl groups.

Detailed explanation is provided below.

### (Film Substrate)

The film substrate used in the present invention is not particularly limited. Examples thereof include triacetyl cellulose, polyethylene terephthalate, cycloolefin polymer, polycarbonate, polyethylene naphthalate, polyethylene, polytrimethylene terephthalate, polypropylene, polybutylene terephthalate, polybutylene naphthalate, polystyrene, polymethyl methacrylate, polystyrene glycidyl methacrylate, and mixtures thereof. In terms of heat resistance, availability, and economical efficiency, it is preferable to use a thermoplastic resin film comprising polyethylene terephthalate, polyethylene naphthalate, or triacetyl cellulose as a constituent material.

### (Hard Coat Layer)

The hard coat layer of the present invention contains one or more electron beam-curable resins, which are binder resins, and one or more leveling agents.

In order to stably ensure the adhesion between the hard coat layer and the film substrate, it is preferable that the one or more electron beam-curable resins used in the hard coat layer in the present invention include at least a polyfunctional (meth)acrylate resin having 3 or more (meth)acryloyl groups in the molecule.

The polyfunctional (meth)acrylate resin having 3 or more (meth)acryloyl groups used in the present invention refers to a (meth)acrylate resin having 3 or more (meth)acryloyl groups in the molecule and curable by electron beams or ultraviolet rays. The number of (meth)acryloyl groups contained in the molecule is preferably 3 to 6, and more preferably 4 to 6. If more than 6 (meth)acryloyl groups are contained in the molecule, the hard coat layer is overly curled due to the cure shrinkage of the one or more electron beam-curable resins, and wrinkles and creases are likely to be formed during roll winding, thereby reducing handling properties in the production process, etc. In contrast, if the number of (meth)acryloyl groups contained in the molecule is less than 3, the desired hardness required for the hard coat layer cannot be obtained.

Specific examples of the polyfunctional (meth)acrylate resin having 3 or more (meth)acryloyl groups used in the present invention include polyol poly(meth)acrylates, such as neopentyl glycol di(meth)acrylate, 1,6-hexanediol di(meth)acrylate, trimethylolpropane tri(meth)acrylate, dipentaerythritol hexa(meth)acrylate, dipentaerythritol penta(meth)acrylate, pentaerythritol tetra(meth)acrylate, pentaerythritol tri(meth)acrylate, and the like.

Use of a polyfunctional (meth)acrylate resin having 3 or more (meth)acryloyl groups in the hard coat layer can improve the adhesion to the substrate.

In the present invention, the abovementioned tri- or higher functional (meth)acrylate resin, that is, a polyfunctional (meth)acrylate resin having 3 or more (meth)acryloyl groups, can be used in combination with other electron beam-curable resins within a range that does not hinder the desired effects. The electron beam-curable resin refers to a transparent resin polymerized and cured by irradiation with electron beams, ultraviolet rays, or the like, and can be suitably selected from, for example, acrylic monomers; oligomers or polymers of urethane acrylate-based resins, polyester acrylate-based resins, and epoxy acrylate-based resins; and the like. Preferable monomers are those comprising UV-curable polyfunctional acrylate having 2 or more (meth)acryloyl groups in the molecule. Specific examples of the UV-curable polyfunctional acrylate having 2 or more (meth)acryloyl groups in the molecule include polyol polyacrylates, such as neopentyl glycol di(meth)acrylate, 1,6-hexanediol di(meth)acrylate, trimethylolpropane tri(meth)acrylate, ditrimethylolpropane tetra(meth)acrylate, pentaerythritol tetra(meth)acrylate, pentaerythritol tri(meth)acrylate, and dipentaerythritol hexa(meth)acrylate; epoxy (meth)acrylates, such as diacrylate of bisphenol A diglycidyl ether, diacrylate of neopentyl glycol diglycidyl ether, and di(meth)acrylate of 1,6-hexanediol diglycidyl ether; polyester (meth)acrylate that can be obtained by esterifying a polyhydric alcohol, polyvalent carboxylic acid and/or anhydride thereof, and acrylic acid; urethane (meth)acrylate obtained by reacting a polyhydric alcohol, polyisocyanate, and hydroxyl group-containing (meth)acrylate; polysiloxane poly(meth)acrylate; and the like.

The amount of the above polyfunctional (meth)acrylate resin having 3 or more (meth)acryloyl groups in the hard coat film in the present invention is 25 to 100 mass %, preferably 50 to 100 mass %, and more preferably 80 to 100 mass %, based on the total weight of the one or more electron beam-curable resins in the hard coat layer.

In the present invention (the first invention above), it is important to use polyester-modified polydimethylsiloxane as the leveling agent of the hard coat layer.

In the present invention, the polyester-modified polydimethylsiloxane refers to a polymer of dimethylsiloxane that is polysiloxane having a repeating unit of an organic modified group and a silicone skeleton, wherein the organic modified group comprises a polyester chain.

Specific examples of the polyester-modified polydimethylsiloxane used in the present invention include commercially available BYK-310, BYK-315, and BYK-370 (all of which are trade names, produced by BYK Japan KK), and the like.

In the present invention, the above polyester-modified polydimethylsiloxane can be used in combination with other types of leveling agents within a range that does not hinder the desired effects. Examples of other types of leveling agents include acrylic leveling agents, silicone-based leveling agents, fluorine-based leveling agents, and the like.

Specific examples of acrylic leveling agents mentioned above include acrylic copolymers, such as BYK-350, BYK-352, BYK-354, BYK-355, and BYK-381; methacrylic copolymers, such as BYK-390 (all of which are trade names, produced by BYK Japan KK); and the like.

Moreover, examples of silicone-based leveling agents mentioned above include copolymers of polyoxyalkylene and polydimethylsiloxane, and the like. Examples of fluorine-based leveling agents mentioned above include copolymers of polyoxyalkylene and fluorocarbon, and the like.

The amount of the polyester-modified polydimethylsiloxane in the hard coat layer of the present invention preferably ranges from 0.1 wt. % to 3.0 wt. % based on the amount of the one or more electron beam-curable resins in the hard coat layer. If the amount of the polyester-modified polydimethylsiloxane is less than 0.1 wt. %, the absolute amount of the one or more leveling agents is low, and it is therefore difficult to uniformly obtain the effects of the present invention. If the amount of the polyester-modified polydimethylsiloxane exceeds 3.0 wt. %, the mixing ratio of uncured substances is overly high, and the hardness of the hard coat layer may therefore be reduced.

Moreover, in the present invention, a value defined by the formula: the film thickness (μm) of the hard coat layer×the total amount (wt. %) of the one or more leveling agents including polyester-modified polydimethylsiloxane, preferably ranges from 0.1 to 60.0 (μm·wt. %), more preferably 0.2 to 40.0 (μm(wt. %), and even more preferably 1.0 to 20.0 ((m(wt. %). If the value defined by the formula: the film thickness ((m) of the hard coat layer×the total amount (wt. %) of the one or more leveling agents, is less than 0.1 ((m(wt. %), the amount of the one or more leveling agents appearing on the surface of the hard coat layer is low, and it is therefore difficult to obtain sufficient leveling adjustment action. In contrast, if the value defined by the formula: the film thickness ((m) of the hard coat layer×the total amount (wt. %) of the one or more leveling agents, exceeds 60.0 ((m(wt. %), the mixing ratio of uncured substances contained in the hard coat layer is overly high, and the hardness of the hard coat layer may therefore be reduced.

The hard coat film of the present invention contains, for example, a polyfunctional (meth)acrylate resin having 3 or more (meth)acryloyl groups as the electron beam-curable resin of the hard coat layer, and polyester-modified polydimethylsiloxane as the leveling agent of the hard coat layer, as described above.

Due to the effect of the polyester-modified polydimethylsiloxane contained therein, the hard coat film of the present invention achieves high leveling adjustment action, maintains a high adhesion to acrylic adhesives, and has a property that the adhesion to natural rubber-based adhesives is reduced in proportion to the amount of polyester-modified polydimethylsiloxane mixed, similar to general leveling agents.

It is known that although hard coat layers have excellent adhesion in a normal-temperature and normal-humidity state, their crosslinked structure is changed when the hard coat layers are placed in a heated state, a wet-heat state, etc., thereby reducing the adhesion to the film substrates.

According to the present invention, it is assumed that the effects attributable to the incorporation of polyester-modified polydimethylsiloxane, that is, high adhesion to acrylic adhesives and excellent peeling properties from natural rubber-based adhesives, are easily maintained because the structure of the polyester-modified polydimethylsiloxane is incorporated into the three-dimensional crosslinked structure of the hard coat layer due to the coexistence with a polyfunctional (meth)acrylate resin having 3 or more (meth)acryloyl groups. Therefore, regarding heating and wet-heat durability, it is assumed that excellent adhesion similar to that in a normal-temperature and normal-humidity state is maintained.

Further, as described above, the above polyester-modified polydimethylsiloxane can be used in combination with other types of leveling agents; however, in the second invention above, it is important to use (in combination) two types of leveling agents, i.e., polyester-modified polydimethylsiloxane and a fluorine group-containing monomer or polymer, as the leveling agents contained in the hard coat layer.

The explanation of the polyester-modified polydimethylsiloxane is omitted because it has already been explained before.

Moreover, in the present invention, the fluorine group-containing monomer or polymer refers to a monomer or polymer having a polymerization unit with 20 or less carbon atoms in which at least one hydrogen atom of an alkyl group, such as a perfluoroalkyl group, is substituted with a fluorine atom, in the molecule.

Specific examples of the monomer or polymer having a fluorine group, such as a perfluoroalkyl group, in the molecule used in the present invention include commercially available Megaface RS-75, Megaface F570, and Megaface F-510 (all of which are trade names, produced by DIC Corporation), and the like.

In the present invention, the above polyester-modified polydimethylsiloxane and fluorine group-containing monomer or polymer can be used in combination with other types of leveling agents within a range that does not hinder the desired effects. Examples of other leveling agents include acrylic leveling agents, silicone-based leveling agents, and the like.

Specific examples of acrylic leveling agents mentioned above include commercially available acrylic copolymers, such as BYK-350, BYK-352, BYK-354, BYK-355, and BYK-381; methacrylic copolymers, such as BYK-390 (all of which are trade names, produced by BYK Japan KK); and the like.

Further, examples of silicone-based leveling agents mentioned above include copolymers of polyoxyalkylene and polydimethylsiloxane, and the like.

The total amount of the one or more leveling agents, including polyester-modified polydimethylsiloxane and a fluorine group-containing monomer or polymer, mixed in the hard coat layer of the present invention preferably ranges from 0.1 wt. % to 3.0 wt. %, based on the total solid content of the hard coat layer. If the total amount of the one or more leveling agents is less than 0.1 wt. %, the absolute amount of the one or more leveling agents is low, and it is therefore difficult to uniformly obtain the effects of the present invention. In contrast, if the total amount of the one or more leveling agents exceeds 3.0 wt. %, the mixing ratio of uncured substances is overly high, and the hardness of the hard coat layer may therefore be reduced.

Moreover, in the second invention, a value defined by the formula: the film thickness (μm) of the hard coat layer×the total amount (wt. %) of the one or more leveling agents, also preferably ranges from 0.1 to 60.0 (μm(wt. %), more preferably 0.2 to 40.0 ((m(wt. %), and even more preferably 1.0 to 20.0. If the value defined by the formula: the film thickness ((m) of the hard coat layer×the total amount (wt. %) of the one or more leveling agents, is less than 0.1 ((m(wt. %), the amount of the one or more leveling agents appearing on the surface of the hard coat layer is low, and it is therefore difficult to obtain sufficient leveling adjustment action. In contrast, if the value defined by the formula: the film thickness ((m) of the hard coat layer×the total amount (wt. %) of the one or more leveling agents, exceeds 60.0 ((m(wt. %), the mixing ratio of uncured substances contained in the hard coat layer is overly high, and the hardness may therefore be reduced.

The mixing ratio of polyester-modified polydimethylsiloxane and a fluorine group-containing monomer or polymer contained in the hard coat layer is preferably within the following range: polyester-modified polydimethylsiloxane:fluorine group-containing monomer or polymer=50 wt. % to 95 wt. %:50 wt. % to 5 wt. %. If the mixing ratio of polyester-modified polydimethylsiloxane among the leveling agents is less than 50 wt. %, the effect of improving the adhesion to acrylic adhesives is hardly obtained. In contrast, if the mixing ratio of fluorine group-containing monomer or polymer is less than 5 wt. %, it is difficult to adjust the adhesion to natural rubber-based adhesives, and such a ratio is not preferable for the treatment to impart adhesion or impart, to the hard coat surface, peeling properties from a protective film or the like.

When the above polyester-modified polydimethylsiloxane and fluorine group-containing monomer or polymer are further used in combination with other types of leveling agents, it is desirable that the mixing ratio of the other types of leveling agents be 20 wt. % or less.

Due to the effect of the polyester-modified polydimethylsiloxane contained in the hard coat layer, the hard coat film of the second invention can have a high adhesion to acrylic adhesives, while achieving high leveling adjustment action owing to the fluorine group-containing monomer or polymer. Moreover, due to the property that the adhesion to natural rubber-based adhesives is reduced in proportion to the amount of the polyester-modified polydimethylsiloxane and fluorine group-containing monomer or polymer contained in the hard coat layer, when a protective film or the like is used on the surface of the hard coat layer of the hard coat film of the present invention, if the protective film or the like uses a natural rubber-based adhesive, peeling properties are excellent, and excellent workability can be ensured.

In the hard coat film of the present invention, the thickness of the hard coat layer is not particularly limited, but is preferably 1 μm to 20 μm, more preferably 1 μm to 15 μm, and even more preferably 1 μm to 10 μm.

If the thickness of the hard coat layer exceeds 20 μm, the hard coat film is overly curled due to the cure shrinkage of the one or more electron beam-curable resins, thereby reducing handling properties. In contrast, if the thickness of the hard coat layer is less than 1 μm, the hard coat layer does not have sufficient hardness, and the function of the hard coat film may not be satisfied.

In addition to one or more electron beam-curable resins and one or more leveling agents mentioned above, the coating solution for forming the hard coat layer may contain, if necessary, a photoinitiator, antifoaming agent, lubricant, ultraviolet absorber, light stabilizer, polymerization inhibitor, wetting dispersant, rheology control agent, antioxidant, antifouling agent, antistatic agent, conducting agent, and the like.

Any known coating method can be used to apply the above coating solution for forming the hard coat layer to the film substrate. Examples of methods include a reverse coating method, gravure coating method, bar coating method, die coating method, spray coating method, kiss coating method, wire-bar coating method, curtain coating method, and the like. These methods can be used singly or in combination of two or more.

Furthermore, the conditions for irradiation with electron beams or ultraviolet rays to cure the hard coat layer applied to the film substrate may be suitably adjusted in accordance with the one or more electron beam-curable resins used and various other chemicals added. When the surface hardness is improved in the present invention, it is preferable to irradiate the surface with electron beams, ultraviolet rays, etc., under conditions in which nitrogen gas or the like is sealed so that the oxygen concentration is 1000 ppm or less.

As explained above, the hard coat film of the present invention has an excellent adhesion to the substrate of the hard coat layer and excellent hardness, has an excellent coating surface without optical unevenness, and has a high adhesion to acrylic adhesives used to join the hard coat layer and a liquid crystal display member, etc., while having excellent peeling properties from natural rubber-based adhesives.

Moreover, the effects obtained by the hard coat film of the present invention are particularly suitable as flat panel members of liquid crystal displays, etc., for which high quality is required for optical performance and surface properties. An optical film for display devices having excellent characteristics can be provided by using the hard coat film of the present invention.

### EXAMPLES

The present invention is described in more detail below with reference to Examples and Comparative Examples; however, the present invention is not limited to these Examples.

### Examples 1 to 15 and Comparative Examples 1 to 17

Coating solutions for hard coat layers were produced by adding one or more leveling agents in the amounts shown in Table 1 or 2 (provided later) to ethyl acetate/butyl acetate=50/50 parts by weight, 95 parts by weight of an electron beam-curable resin comprising, as a main component, pentaerythritol triacrylate having 3 (meth)acryloyl groups (trade name: Light Acrylate PE-3A, produced by Kyoeisha Chemical Co., Ltd.), and 5 parts by weight of a photoinitiator (trade name: Irgacure-184, produced by Ciba Japan K.K.). The resulting coating solutions were each applied to a triacetyl cellulose (TAC) film having a thickness of 80 μm using a Meyer bar, and dried at 80° C. for 1 minute to volatilize the solvent, followed by curing by UV irradiation at an integrated light intensity of 300 mJ/cm². Thus, the hard coat films of Examples 1 to 15 and Comparative Examples 1 to 17 were produced. The coating thickness (shown in Tables 1 and 2) of each hard coat layer was adjusted by suitably selecting the diameter (yarn count) of the Meyer bar.

Regarding the leveling agents shown in Tables 1 and 2, all of the trade names: BYK-branch numbers are available from BYK Japan KK, and the trade name: Megaface RS-75 is available from DIC Corporation.

### Examples 16 to 20

Coating solutions were produced in the same proportion as the above coating solutions, except that the resin component of the above coating solutions was changed to 95 parts by weight of dipentaerythritol hexaacrylate having 6 (meth)acryloyl groups (trade name: Light Acrylate DPE-6A, produced by Kyoeisha Chemical Co., Ltd.). The hard coat films of Examples 16 to 20 containing one or more leveling agents and having the coating thickness shown in Table 1 were produced in the same manner as above.

### Comparative Examples 18 to 20

Coating solutions were produced in the same proportion as the above coating solutions, except that the resin component of the above coating solutions was changed to 95 parts by weight of neopentyl glycol diacrylate having 2 (meth)acryloyl groups (trade name: Light Acrylate NP-A, produced by Kyoeisha Chemical Co., Ltd.). The hard coat films of Comparative Examples 18 to 20 containing the leveling agent and having the coating thickness shown in Table 2 were produced in the same manner as above.

The following tests were conducted on each of the obtained hard coat films, and the results were summarized in Table 1 (Examples) and Table 2 (Comparative Examples).

### [Evaluation Criteria]

### (1) Tape Adhesion Test

The tape adhesion test was performed according to JIS-K6849. Measurement samples were each cut into a size of 30 mm×250 mm, and a glass plate, which served as a supporter, was bonded to the surface opposite to the hard coat surface. Each of the following adhesive tapes was bonded to the hard coat surface, and measurements were carried out using a tension tester Strograph VS05D (produced by Toyo Tester Kogyo K.K.) at a peeling angle of 180° at a peel rate of 300 mm/min.
Acrylic adhesive tape: Electrically insulating polyester substrate adhesive tape No. 31B (produced by Nitto Denko Corporation; width: 25 mm)

The evaluation criteria are as follows.

⊚: No. 31B tape adhesion is 5 N/25 mm or more.

◯: No. 31B tape adhesion is 4 N/25 mm or more to less than 5 N/25 mm.

Δ: No. 31B tape adhesion is 3 N/25 mm or more to less than 4 N/25 mm.

X: No. 31B tape adhesion is less than 3 N/25 mm.
Natural rubber-based adhesive tape: Sekisui Cellophane Tape No. 252 (produced by Sekisui Chemical Co., Ltd.; width: 24 mm)

The evaluation criteria are as follows.

⊚: No. 252 tape adhesion is less than 4 N/24 mm.

◯: No. 252 tape adhesion is 4 N/24 mm or more to less than 5 N/24 mm.

Δ: No. 252 tape adhesion is 5 N/24 mm or more to less than 6 N/24 mm.

X: No. 252 tape adhesion is 6 N/24 mm or more.

### (2) Adhesion Test

The adhesion test was performed according to JIS-K5600-5-6.

Hundred squares were formed on each hard coat layer using a cutter, and a peel test using a natural rubber-based adhesive tape (Sekisui Cellophane Tape No. 252) was performed by a cross-cut method. The adhesion was evaluated as described below based on the residual ratio of the hard coat layer in the 100 squares.

⊚: Adhesion according to the cross-cut method is 100%.

◯: Adhesion according to the cross-cut method is 99%.

Δ: Adhesion according to the cross-cut method is 95% or more to less than 99%.

X: Adhesion according to the cross-cut method is less than 95%.

### (3) Heating Durability

Each hard coat film was treated in an air thermostatic chamber (produced by Yamato Scientific Co., Ltd.) at a temperature of 90° C. for 24 hours. The obtained samples were evaluated by the adhesion test described above.

### (4) Wet-Heat Durability

Each hard coat film was treated in a thermo-hygrostat (produced by ESPEC Corp.) at a temperature of 65° C. and a humidity of 95% for 24 hours in the same manner as in the above heating durability, and the obtained samples were evaluated by the adhesion test described above.

### (5) Optical Unevenness

The hard coat films were each cut into an area of 10 cm×15 cm to produce sample films. A black luster tape was bonded to the surface opposite to the hard coat layer of each sample film, and the hard coat surface was placed face-up. Using a three-wavelength daylight white fluorescent lamp (National Palook F.L15EX-N15W) as a light source, the reflected light was visually observed from an oblique upper side.

⊚: No interference unevenness is observed.

Δ: Interference unevenness is slightly observed.

X: Interference unevenness is clearly observed.

### (6) Hardness

The surface of each hard coat film was rubbed 10 times with #0000 steel wool while applying a load of 4.9 N/φ25 mm, and the formation of scratches and the degree of scratches were visually observed. The evaluation criteria are as follows. ⊚ and ◯ were regarded as good.

⊚: No scratches are formed.

◯: 5 or less scratches are formed.

Δ: 6 to 10 scratches are formed.

X: Countless scratches are formed.

TABLE 1

| | Resin | Leveling agent | | | | | | | | | | | |
|---|---|---|---|---|---|---|---|---|---|---|---|---|---|
| | Number of | Formulation 1 | | Formulation 2 | | Coating | | Heating | Wet-heat | Tape | Tape | Optical | |
| | functional | | Mixing | | Mixing | thickness | Adhesion | durability | durability | adhesion | adhesion | Uneven- | Hard- |
| | groups | Type | ratio | Type | ratio | μm | Cross-cut | Cross-cut | Cross-cut | No. 31B | No. 252 | ness | ness |
| Ex. 1 | 3 | BYK-310 | 3 | — | — | 1 | ⊚ | ⊚ | ⊚ | ⊚ | ⊚ | ◯ | ◯ |
| Ex. 2 | 3 | BYK-310 | 0.1 | — | — | 1 | ◯ | ◯ | ◯ | ⊚ | ◯ | ◯ | ◯ |
| Ex. 3 | 3 | BYK-310 | 3 | — | — | 20 | ⊚ | ⊚ | ⊚ | ◯ | ⊚ | ◯ | ◯ |
| Ex. 4 | 3 | BYK-310 | 0.1 | — | — | 20 | ⊚ | ⊚ | ⊚ | ⊚ | ⊚ | ◯ | ◯ |
| Ex. 5 | 3 | BYK-315 | 3 | — | — | 1 | ⊚ | ⊚ | ⊚ | ⊚ | ⊚ | ◯ | ◯ |
| Ex. 6 | 3 | BYK-315 | 0.1 | — | — | 1 | ◯ | ◯ | ◯ | ⊚ | ◯ | ◯ | ◯ |
| Ex. 7 | 3 | BYK-315 | 3 | — | — | 20 | ⊚ | ⊚ | ⊚ | ◯ | ⊚ | ◯ | ◯ |
| Ex. 8 | 3 | BYK-315 | 0.1 | — | — | 20 | ⊚ | ⊚ | ⊚ | ⊚ | ⊚ | ◯ | ◯ |
| Ex. 9 | 3 | BYK-370 | 3 | — | — | 1 | ⊚ | ⊚ | ⊚ | ⊚ | ⊚ | ◯ | ◯ |
| Ex. 10 | 3 | BYK-370 | 0.1 | — | — | 1 | ◯ | ◯ | ◯ | ⊚ | ◯ | ◯ | ◯ |
| Ex. 11 | 3 | BYK-370 | 3 | — | — | 20 | ⊚ | ⊚ | ⊚ | ◯ | ⊚ | ◯ | ◯ |
| Ex. 12 | 3 | BYK-370 | 0.1 | — | — | 20 | ⊚ | ⊚ | ⊚ | ⊚ | ⊚ | ◯ | ◯ |
| Ex. 13 | 3 | BYK-310 | 1 | RS-75 | 0.3 | 2 | ⊚ | ⊚ | ⊚ | ⊚ | ⊚ | ◯ | ◯ |
| Ex. 14 | 3 | BYK-310 | 3.5 | — | — | 2 | ⊚ | ⊚ | ⊚ | ◯ | ⊚ | ◯ | Δ |
| Ex. 15 | 3 | BYK-310 | 0.05 | — | — | 2 | Δ | Δ | Δ | ⊚ | Δ | Δ | ◯ |
| Ex. 16 | 6 | BYK-310 | 3 | — | — | 1 | ⊚ | ⊚ | ⊚ | ⊚ | ⊚ | ◯ | ⊚ |
| Ex. 17 | 6 | BYK-310 | 0.1 | — | — | 1 | ◯ | ◯ | ◯ | ⊚ | ◯ | ◯ | ⊚ |
| Ex. 18 | 6 | BYK-310 | 3 | — | — | 20 | ⊚ | ⊚ | ⊚ | ◯ | ⊚ | ◯ | ⊚ |
| Ex. 19 | 6 | BYK-310 | 0.1 | — | — | 20 | ⊚ | ⊚ | ⊚ | ⊚ | ⊚ | ◯ | ⊚ |
| Ex. 20 | 6 | BYK-310 | 1 | RS-75 | 0.3 | 2 | ⊚ | ⊚ | ⊚ | ⊚ | ⊚ | ◯ | ⊚ |

BYK-310: polyester modified polydimethylsiloxane
BYK-315: polyester-modified polydimethylsiloxane
BYK-370: polyester-modified polydimethylsiloxane
Megaface RS-75: fluorine group-containing UV-reactive oligomer

TABLE 2

| | Resin | Leveling agent | | | | | | | | | | | |
|---|---|---|---|---|---|---|---|---|---|---|---|---|---|
| | Number of | Formulation 1 | | Formulation 2 | | Coating | | Heating | Wet-heat | Tape | Tape | Optical | |
| | functional | | Mixing | | Mixing | thickness | Adhesion | durability | durability | adhesion | adhesion | Uneven- | Hard- |
| | groups | Type | ratio | Type | ratio | μm | Cross-cut | Cross-cut | Cross-cut | No. 31B | No. 252 | ness | ness |
| Comp. | 3 | Not added | — | — | — | 1 | X | X | X | ⊚ | X | X | Δ |
| Ex. 1 | | | | | | | | | | | | | |
| Comp. | 3 | Not added | — | — | — | 20 | X | X | X | ⊚ | X | X | Δ |
| Ex. 2 | | | | | | | | | | | | | |
| Comp. | 3 | BYK-300 | 3 | — | — | 1 | ⊚ | ⊚ | ⊚ | X | ⊚ | ◯ | ◯ |
| Ex. 3 | | | | | | | | | | | | | |
| Comp. | 3 | BYK-300 | 0.1 | — | — | 1 | Δ | Δ | Δ | ◯ | Δ | ◯ | ◯ |
| Ex. 4 | | | | | | | | | | | | | |
| Comp. | 3 | BYK-300 | 3 | — | — | 20 | ⊚ | ⊚ | ⊚ | X | ⊚ | ◯ | ◯ |
| Ex. 5 | | | | | | | | | | | | | |
| Comp. | 3 | BYK-300 | 0.1 | — | — | 20 | ◯ | ◯ | ◯ | X | ◯ | ◯ | ◯ |
| Ex. 6 | | | | | | | | | | | | | |
| Comp. | 3 | BYK-350 | 3 | — | — | 1 | Δ | Δ | Δ | X | X | Δ | ◯ |
| Ex. 7 | | | | | | | | | | | | | |
| Comp. | 3 | BYK-350 | 0.1 | — | — | 1 | X | X | X | ◯ | X | Δ | ◯ |
| Ex. 8 | | | | | | | | | | | | | |
| Comp. | 3 | BYK-350 | 3 | — | — | 20 | ◯ | ◯ | ◯ | X | Δ | Δ | ◯ |
| Ex. 9 | | | | | | | | | | | | | |
| Comp. | 3 | BYK-350 | 0.1 | — | — | 20 | Δ | Δ | Δ | X | X | Δ | ◯ |
| Ex. 10 | | | | | | | | | | | | | |
| Comp. | 3 | Megaface | 3 | — | — | 1 | ⊚ | ⊚ | ⊚ | X | ⊚ | ◯ | ◯ |
| Ex. 11 | | RS-75 | | | | | | | | | | | |
| Comp. | 3 | Megaface | 0.1 | — | — | 1 | Δ | Δ | Δ | Δ | ◯ | ◯ | ◯ |
| Ex. 12 | | RS-75 | | | | | | | | | | | |
| Comp. | 3 | Megaface | 3 | — | — | 20 | ⊚ | ⊚ | ⊚ | X | ⊚ | ◯ | ◯ |
| Ex. 13 | | RS-75 | | | | | | | | | | | |
| Comp. | 3 | Megaface | 0.1 | — | — | 20 | ⊚ | ⊚ | ⊚ | X | ⊚ | ◯ | ◯ |
| Ex. 14 | | RS-75 | | | | | | | | | | | |
| Comp. | 3 | BYK-300 | 0.3 | BYK-3550 | 0.3 | 2 | Δ | Δ | Δ | X | Δ | ◯ | ◯ |
| Ex. 15 | | | | | | | | | | | | | |
| Comp. | 3 | BYK-300 | 0.3 | Megaface | 0.3 | 2 | ⊚ | ⊚ | ⊚ | X | ⊚ | ◯ | ◯ |
| Ex. 16 | | | | RS-75 | | | | | | | | | |
| Comp. | 3 | BYK-350 | 0.3 | Megaface | 0.3 | 2 | ⊚ | ⊚ | ⊚ | X | ⊚ | ◯ | ◯ |
| Ex. 17 | | | | RS-75 | | | | | | | | | |
| Comp. | 2 | BYK-310 | 0.3 | — | — | 2 | Δ | X | X | ⊚ | ⊚ | ◯ | Δ |
| Ex. 18 | | | | | | | | | | | | | |
| Comp. | 2 | BYK-315 | 0.3 | — | — | 2 | Δ | X | X | ⊚ | ⊚ | ◯ | Δ |
| Ex. 19 | | | | | | | | | | | | | |
| Comp. | 2 | BYK-370 | 0.3 | — | — | 2 | Δ | X | X | ⊚ | ⊚ | ◯ | Δ |
| Ex. 20 | | | | | | | | | | | | | |

BYK-310: polyester-modified polydimethylsiloxane
BYK-315: polyester-modified polydimethylsiloxane
BYK-370: polyester-modified polydimethylsiloxane
BYK-300: polyether-modified polydimethylsiloxane
BYK-350: acrylic copolymer
Megaface RS-75: fluorine group-containing UV-reactive oligomer
BYK-3550: silicone-modified acrylate

The results of Table 1 above indicate that the hard coat films of the Examples of the present invention, which contained a polyfunctional (meth)acrylate resin having 3 or more (meth)acryloyl groups as the electron beam-curable resin of the hard coat layer, and polyester-modified polydimethylsiloxane as the leveling agent of the hard coat layer, had excellent results regarding all the characteristics, i.e., adhesion, heating durability, wet-heat durability, acrylic adhesive tape adhesion, natural rubber-based adhesive tape adhesion (peeling properties), optical unevenness, and hardness. That is, the present invention can obtain hard coat films that have an excellent adhesion to the substrate of the hard coat layer and excellent hardness, that have an excellent coating surface without optical unevenness, and that have a high adhesion to acrylic adhesives used to join the hard coat layer and a liquid crystal display member, etc., while having excellent peeling properties from natural rubber-based adhesives.

In addition, excellent results were also obtained by the combined use of the polyester-modified polydimethylsiloxane of the present invention and another type of leveling agent (a fluorine-based leveling agent) as the leveling agents (Examples 13 and 20).

Furthermore, in Example 14, in which the amount of the polyester-modified polydimethylsiloxane of the present invention was higher than the preferred range, hardness was slightly reduced. On the other hand, in Example 15, in which the amount of the polyester-modified polydimethylsiloxane of the present invention was lower than the preferred range, adhesion, heating durability, wet-heat durability, natural rubber-based adhesive tape adhesion (peeling properties), optical unevenness, and like characteristics were insufficient.

In contrast, as is clear from the results of Table 2 above, in Comparative Examples 1 and 2, in which a polyfunctional (meth)acrylate resin having 3 or more (meth)acryloyl groups was contained as the electron beam-curable resin of the hard coat layer, but the polyester-modified polydimethylsiloxane of the present invention was not added as the leveling agent, acrylic adhesive tape adhesion was excellent, while the other characteristics were not obtained. Moreover, even when a leveling agent different from that of the present invention was added (Comparative Examples 3 to 14), any of the above characteristics was insufficient. Further, even when two types of leveling agents different from that of the present invention were used in combination (Comparative Examples 15 to 18), any of the above characteristics was also insufficient, and acrylic adhesive tape adhesion was particularly inferior. Furthermore, in a case in which a (meth)acrylate resin having 2 (meth)acryloyl groups as functional groups was contained as the electron beam-curable resin of the hard coat layer, even when the polyester-modified polydimethylsiloxane of the present invention was added as the leveling agent (Comparative Examples 18 to 20), the effects of the present invention were not obtained. In particular, adhesion, heating durability, wet-heat durability, hardness, and like characteristics were inferior.

The above results demonstrate that the excellent effects of the present invention described above can be obtained only when a polyfunctional (meth)acrylate resin having 3 or more (meth)acryloyl groups is contained as the electron beam-curable resin of the hard coat layer, and when polyester-modified polydimethylsiloxane is contained as the leveling agent of the hard coat layer.

### Examples 21 to 31 and Comparative Examples 21 to 25

Coating solutions were produced by adding one or more leveling agents in the amounts shown in Table 3 or 4 (provided later) to ethyl acetate/butyl acetate=50/50 parts by weight, 95 parts by weight of an electron beam-curable resin comprising, as a main component, pentaerythritol triacrylate (trade name: Light Acrylate PE-3A, produced by Kyoeisha Chemical Co., Ltd.), and 5 parts by weight of a photoinitiator (trade name: Irgacure-184, produced by Ciba Japan K.K.). The resulting coating solutions were each applied to a triacetyl cellulose (TAC) film having a thickness of 80 μm using a Meyer bar, and dried at 80° C. for 1 minute to volatilize the solvent, followed by curing by UV irradiation at an integrated light intensity of 300 mJ/cm². Thus, the hard coat films of Examples 21 to 31 and Comparative Examples 21 to 25 were produced.

Regarding the leveling agents shown in Tables 3 and 4, all of the trade names: BYK-branch numbers are available from BYK Japan KK, and all of the trade names: Megaface-branch numbers are available from DIC Corporation.

The following tests were conducted on each of the obtained hard coat films, and the results were summarized in Table 3 (Examples) and Table 4 (Comparative Examples).

### (1) Tape Adhesion Test

The tape adhesion test was performed according to JIS-K6849. Measurement samples were each cut into a size of 30 mm×250 mm, and a glass plate, which served as a supporter, was bonded to the surface opposite to the hard coat surface. Each of the following adhesive tapes was bonded to the hard coat surface, and measurements were carried out using a tension tester Strograph VS05D (produced by Toyo Tester Kogyo K.K.) at a peeling angle of 180° at a peel rate of 300 mm/min.
Acrylic adhesive tape: Electrically insulating polyester substrate adhesive tape No. 31B (produced by Nitto Denko Corporation; width: 25 mm)

The evaluation criteria are as follows.

⊚: No. 31B tape adhesion is 5 N/25 mm or more.

◯: No. 31B tape adhesion is 4 N/25 mm or more to less than 5 N/25 mm.

Δ: No. 31B tape adhesion is 3 N/25 mm or more to less than 4 N/25 mm.

X: No. 31B tape adhesion is less than 3 N/25 mm.
Natural rubber-based adhesive tape: Sekisui Cellophane Tape No. 252 (produced by Sekisui Chemical Co., Ltd.; width: 24 mm)

The evaluation criteria are as follows.

⊚: No. 252 tape adhesion is less than 4 N/24 mm.

◯: No. 252 tape adhesion is 4 N/24 mm or more to less than 5 N/24 mm.

Δ: No. 252 tape adhesion is 5 N/24 mm or more to less than 6 N/24 mm.

X: No. 252 tape adhesion is 6 N/24 mm or more.

### (2) Adhesion Test

The adhesion test was performed according to JIS-K5600-5-6.

Hundred squares were formed on each hard coat layer using a cutter, and a peel test using a natural rubber-based adhesive tape (Sekisui Cellophane Tape No. 252) was performed by a cross-cut method. The adhesion was evaluated as described below based on the residual ratio of the hard coat layer in the 100 squares.

The evaluation criteria are as follows.

⊚: Adhesion according to the cross-cut method is 100%.

◯: Adhesion according to the cross-cut method is 99%.

Δ: Adhesion according to the cross-cut method is 95% or more to less than 99%.

X: Adhesion according to the cross-cut method is less than 95%.

### (3) Optical Unevenness

The produced hard coat films were each cut into an area of 10 cm×15 cm to produce sample films. A black luster tape was bonded to the surface opposite to the hard coat layer of each sample film, and the hard coat surface was placed face-up. Using a three-wavelength daylight white fluorescent lamp (National Palook F.L15EX-N15W) as a light source, the reflected light was visually observed from an oblique upper side.

The evaluation criteria are as follows.

⊚: No interference unevenness is observed.

◯: Almost no interference unevenness is observed.

: Interference unevenness is very slightly observed.

Δ: Interference unevenness is slightly observed.

X: Interference unevenness is clearly observed.

### (4) Hardness

The surface of each hard coat film was rubbed 10 times with #0000 steel wool while applying a load of 4.9 N/φ25 mm, and the formation of scratches and the degree of scratches were visually observed. The evaluation criteria are as follows. , ◯, and ⊚ were regarded as good.

⊚: No scratches are formed.

◯: 4 or less scratches are formed.

: 5 or 6 scratches are observed.

Δ: 6 to 10 scratches are formed.

X: Countless scratches are formed.

TABLE 3
Examples

| | Leveling agent | | | | | | | Hard coat | Hard coat | Adhe- | | | | |
|---|---|---|---|---|---|---|---|---|---|---|---|---|---|---|
| | Formulation 1 | | Formulation 2 | | Formulation 3 | | Total | film | film | sion | Tape | Tape | Optical | |
| | | Mixing | | Mixing | | Mixing | amount | thickness | thickness × | Cross- | adhesion | adhesion | Uneven- | Hard- |
| | Type | ratio | Type | ratio | Type | ratio | wt. % | μm | total amount | cut | No. 31B | No. 252 | ness | ness |
| Ex. 21 | BYK- | 60 | Megaface | 40 | — | — | 0.5 | 2 | 1 | ⊚ | ⊚ | ⊚ | ⊚ | ◯ |
| | 310 | | RS-75 | | | | | | | | | | | |
| Ex. 22 | BYK- | 60 | Megaface | 40 | — | — | 0.5 | 2 | 1 | ⊚ | ⊚ | ⊚ | ⊚ | ◯ |
| | 370 | | RS-75 | | | | | | | | | | | |
| Ex. 23 | BYK- | 60 | Megaface | 40 | — | — | 0.5 | 2 | 1 | ⊚ | ⊚ | ⊚ | ⊚ | ◯ |
| | 310 | | F570 | | | | | | | | | | | |
| Ex. 24 | BYK- | 60 | Megaface | 40 | — | — | 0.5 | 2 | 1 | ⊚ | ⊚ | ⊚ | ⊚ | ◯ |
| | 370 | | F570 | | | | | | | | | | | |
| Ex. 25 | BYK- | 60 | Megaface | 40 | — | — | 0.08 | 2 | 0.2 | ◯ | ⊚ | ◯ | ◯ | ◯ |
| | 310 | | RS-75 | | | | | | | | | | | |
| Ex. 26 | BYK- | 60 | Megaface | 40 | — | — | 3.2 | 2 | 6.4 | ⊚ | ◯ | ⊚ | ⊚ | ◯ |
| | 310 | | RS-75 | | | | | | | | | | | |
| Ex. 27 | BYK- | 50 | Megaface | 50 | — | — | 0.5 | 2 | 1 | ⊚ | ⊚ | ⊚ | ⊚ | ◯ |
| | 310 | | RS-75 | | | | | | | | | | | |
| Ex. 28 | BYK- | 40 | Megaface | 60 | — | — | 0.5 | 2 | 1 | ⊚ | ◯ | ⊚ | ⊚ | ◯ |
| | 310 | | RS-75 | | | | | | | | | | | |
| Ex. 29 | BYK- | 55 | Megaface | 35 | BYK- | 10 | 0.5 | 2 | 1 | ⊚ | ⊚ | ⊚ | ⊚ | ◯ |
| | 310 | | RS-75 | | 350 | | | | | | | | | |
| Ex. 30 | BYK- | 60 | Megaface | 40 | — | — | 0.1 | 0.5 | 0.05 | ◯ | ⊚ | ◯ | | |
| | 310 | | RS-75 | | | | | | | | | | | |
| Ex. 31 | BYK- | 60 | Megaface | 40 | — | — | 3 | 21 | 63 | ⊚ | ◯ | ⊚ | ⊚ | |
| | 310 | | RS-75 | | | | | | | | | | | |

BYK-310: polyester modified polydimethylsiloxane
BYK-370: polyester modified polydimethylsiloxane
BYK-350: acrylic copolymer
Megaface RS-75: fluorine group-containing UV-reactive oligomer
Megaface F570: fluorine group-containing oligomer

TABLE 4
Comparative Examples

| | Leveling agent | | | | | Hard coat | Hard coat | Adhe- | | | | |
|---|---|---|---|---|---|---|---|---|---|---|---|---|
| | Formulation 1 | | Formulation 2 | | Total | film | film | sion | Tape | Tape | Optical | |
| | | Mixing | | Mixing | amount | thickness | thickness × | Cross- | adhesion | adhesion | Uneven- | Hard- |
| | Type | ratio | Type | ratio | wt. % | μm | total amount | cut | No. 31B | No. 252 | ness | ness |
| Comp. | BYK-300 | 100 | — | — | 0.5 | 2 | 1 | Δ | ◯ | Δ | ◯ | ⊚ |
| Ex. 21 | | | | | | | | | | | | |
| Comp. | BYK-350 | 100 | — | — | 0.5 | 2 | 1 | X | ⊚ | X | Δ | ◯ |
| Ex. 22 | | | | | | | | | | | | |
| Comp. | Megaface | 100 | — | — | 0.5 | 2 | 1 | ⊚ | X | ⊚ | ⊚ | ⊚ |
| Ex. 23 | RS-75 | | | | | | | | | | | |
| Comp. | BYK-300 | 60 | Megaface | 40 | 0.5 | 2 | 1 | ⊚ | X | ⊚ | ⊚ | ⊚ |
| Ex. 24 | | | RS-75 | | | | | | | | | |
| Comp. | BYK-350 | 60 | Megaface | 40 | 0.5 | 2 | 1 | ⊚ | X | ⊚ | ⊚ | ⊚ |
| Ex. 25 | | | RS-75 | | | | | | | | | |

BYK-300: polyether modified polydimethylsiloxane
BYK-350: acrylic copolymer
Megaface RS-75: fluorine group-containing UV-reactive oligomer

The results of Table 3 above indicated that the hard coat films of the Examples of the present invention, in which two types of leveling agents, i.e., polyester-modified polydimethylsiloxane and a fluorine group-containing monomer or polymer, are used in combination as the leveling agents contained in the hard coat layer, are excellent in all the characteristics, i.e., adhesion to the hard coat layer, adhesion to acrylic adhesive tapes, adhesion (peeling properties) to natural rubber-based adhesive tapes, optical unevenness, and hardness. That is, according to the hard coat films of the Examples of the present invention, the resulting hard coat films have an excellent adhesion to the substrate of the hard coat layer and excellent hardness, have an excellent coating surface without optical unevenness, and have a high adhesion to acrylic adhesives used to join the hard coat layer and a liquid crystal display member, etc., while having excellent peeling properties from natural rubber-based adhesives.

On the other hand, the results of Table 4 above indicated that in Comparative Example 21, in which polyether-modified polydimethylsiloxane was used alone as the leveling agent, excellent results were not obtained regarding adhesion to the hard coat layer and adhesion (peeling properties) to natural rubber-based adhesive tapes. Further, in Comparative Example 22, in which an acrylic copolymer was used alone as the leveling agent, adhesion to the hard coat layer and adhesion (peeling properties) to natural rubber-based adhesive tapes were not obtained, and optical unevenness was observed. Moreover, in Comparative Example 23, in which a UV-reactive oligomer containing a fluorine group was used alone as the leveling agent, adhesion to acrylic adhesive tapes was not obtained. Furthermore, in Comparative Example 24, in which two types of leveling agents, i.e., polyether-modified polydimethylsiloxane and a UV-reactive oligomer containing a fluorine group, were used in combination as the leveling agents, and in Comparative Example 25, in which two types of leveling agents, i.e., an acrylic copolymer and a UV-reactive oligomer containing a fluorine group, were used in combination as the leveling agents, adhesion to acrylic adhesive tapes was not obtained. In conclusion, in the above Comparative Examples, hard coat films excellent in all the characteristics, i.e., adhesion to the hard coat layer, adhesion to acrylic adhesive tape, adhesion (peeling properties) to natural rubber-based adhesive tapes, optical unevenness, and hardness, cannot be obtained.

1. A hard coat film comprising a film substrate, and a hard coat layer formed on the film substrate and containing one or more electron beam-curable resins and one or more leveling agents,
wherein the one or more leveling agents include polyester-modified polydimethylsiloxane.

2. A hard coat film comprising a film substrate, and a hard coat layer formed on the film substrate and containing one or more electron beam-curable resins and one or more leveling agents,
wherein polyester-modified polydimethylsiloxane and a fluorine group-containing monomer or polymer are contained as the one or more leveling agents.

3. The hard coat film according to claim 1, wherein the one or more electron beam-curable resins include a polyfunctional (meth)acrylate resin having 3 or more (meth)acryloyl groups.

4. The hard coat film according to claim 1, wherein the amount of the polyester-modified polydimethylsiloxane ranges from 0.1 wt. % to 3.0 wt. % based on the amount of the one or more electron beam-curable resins in the hard coat layer.

5. The hard coat film according to claim 2, wherein the total amount of the one or more leveling agents, including polyester-modified polydimethylsiloxane and a fluorine group-containing monomer or polymer, contained in the hard coat layer ranges from 0.1 wt. % to 3.0 wt. % based on the amount of the one or more electron beam-curable resins.

6. The hard coat film according to claim 5, wherein the compounding ratio of polyester-modified polydimethylsiloxane and a fluorine group-containing monomer or polymer, which are the one or more leveling agents contained in the hard coat layer, is within the following range: polyester-modified polydimethylsiloxane:fluorine group-containing monomer or polymer=50 wt. % to 95 wt. %:50 wt. % to 5 wt. %.

7. The hard coat film according to claim 1, wherein the hard coat layer has a film thickness ranging from 1 to 20 μm.

8. The hard coat film according to claim 1, wherein a value defined by the formula: the film thickness (μm) of the hard coat layer×the total amount (wt. %) of the one or more leveling agents mixed, ranges from 0.1 to 60.0 (μm·wt. %).

9. An optical film for a display device, the optical film using the hard coat film according to claim 1.

10. An optical film for a display device, the optical film using the hard coat film according to claim 2.

11. The hard coat film according to claim 2, wherein the hard coat layer has a film thickness ranging from 1 to 20 μm.

12. The hard coat film according to claim 2, wherein a value defined by the formula: the film thickness (μm) of the hard coat layer×the total amount (wt. %) of the one or more leveling agents mixed, ranges from 0.1 to 60.0 (μm·wt. %).

13. The hard coat film according to claim 2, wherein the one or more electron beam-curable resins include a polyfunctional (meth)acrylate resin having 3 or more (meth)acryloyl groups.

14. The hard coat film according to claim 3, wherein the amount of the polyester-modified polydimethylsiloxane ranges from 0.1 wt. % to 3.0 wt. % based on the amount of the one or more electron beam-curable resins in the hard coat layer.

15. The hard coat film according to claim 3, wherein the total amount of the one or more leveling agents, including polyester-modified polydimethylsiloxane and a fluorine group-containing monomer or polymer, contained in the hard coat layer ranges from 0.1 wt. % to 3.0 wt. % based on the amount of the one or more electron beam-curable resins.

16. The hard coat film according to claim 15, wherein the compounding ratio of polyester-modified polydimethylsiloxane and a fluorine group-containing monomer or polymer, which are the one or more leveling agents contained in the hard coat layer, is within the following range: polyester-modified polydimethylsiloxane:fluorine group-containing monomer or polymer=50 wt. % to 95 wt. %:50 wt. % to 5 wt. %.
